(19) United States
(12) Patent Application Publication
(10) Pub. No.: US 2023/0402869 A1
(43) Pub. Date: Dec. 14, 2023

(54) APPARATUS AND METHOD FOR PCS MANAGEMENT IN OPTIMAL EFFICIENCY RANGE

(71) Applicant: STANDARD ENERGY INC., Daejeon (KR)

(72) Inventors: Dong Young Lee, Daejeon (KR); Sang Hyun Park, Daejeon (KR)

(73) Assignee: STANDARD ENERGY INC., Daejeon (KR)

(21) Appl. No.: 18/208,927

(22) Filed: Jun. 13, 2023

(30) Foreign Application Priority Data
Jun. 13, 2022 (KR) 10-2022-0071734
Aug. 26, 2022 (KR) 10-2022-0107295
Nov. 8, 2022 (KR) 10-2022-0147628
Jan. 31, 2023 (KR) 10-2023-0013342

(51) Int. Cl. H02J 7/02; B60L 53/63; H02J 3/32

(52) U.S. Cl. CPC H02J 7/02; B60L 53/63; H02J 3/322; B60L 53/64

(57) ABSTRACT

A power control apparatus includes an energy storage system that is connected to a power grid and includes a battery; a power conversion system (PCS) operatively connected to the power grid and the energy storage system; and a control unit configured to control a charging procedure and a discharging procedure for the battery by giving a priority to power conversion efficiency of the PCS. A control method of a power conversion apparatus includes using a power conversion unit to provide a control of transferring at least one of power of a power grid and power of an energy storage system to an electric vehicle charging system, and a management control to correspond to an optimal efficiency range with respect to power conversion by controlling charging/discharging of the energy storage system according to an electric vehicle charging speed.

### CROSS-REFERENCE TO RELATED APPLICATIONS

This application claims the priority of Korean Patent Application Nos. 10-2022-0071734 filed on Jun. 13, 2022, 10-2022-0107295 filed on Aug. 26, 2022, 10-2022-0147628 filed on Nov. 8, 2022, and 10-2023-0013342 filed on Jan. 31, 2023, in the Korean Intellectual Property Office, the disclosure of which is incorporated herein by reference.

### BACKGROUND OF THE DISCLOSURE

### Technical Field

The present disclosure relates to an integrated system in which an energy storage system (ESS) and a charger are combined, and more particularly, to an apparatus and a method for a power conversion system (PCS) or power conversion unit management in an optimal efficiency range in an integrated system in which an energy storage system (ESS) and a charger are combined.

### Background Art

An energy storage system (ESS) is a system that stores electricity in a battery and the like, and then supplies power to a grid. The energy storage system can perform charging and discharging.

In recent years, as the use of electric vehicles has expanded, an electric vehicle charger is disposed in various spaces. However, the use of the electric vehicle charger can increase electricity consumption of the grid and influence other electricity consumption in the corresponding space. In particular, when the electricity consumption is soaring, there is a problem in which the use of the electric vehicle charger is limited.

Therefore, a method for stably performing charging in a space in which the charger is disposed and providing a system therefor is required.

### SUMMARY OF THE DISCLOSURE

An object to be achieved by the present disclosure is to provide a system for electric vehicle charging, in which an energy storage system assists power use of a charger to stabilize power supply of a grid, and is driven by linking ESS power.

Another object to be achieved by the present disclosure is to provide a control method to achieve power conversion according to a specific charging/discharging range of the VIB ESS so as to satisfy an optimal efficiency range of the power conversion system (PCS) by considering power efficiency.

The object of the present disclosure is not limited to the aforementioned object, and other objects, which are not mentioned above, will be apparent to a person having ordinary skill in the art from the following description.

According to an aspect of the present disclosure, provided is a power control system including: an energy storage system (ESS) connected to a power grid and having a battery; a power conversion system (PCS) operatively connected to the power grid and the energy storage system (ESS); and a control unit providing a control to perform a charging procedure and a discharging procedure for the battery by giving a priority to power conversion efficiency of the power conversion system (PCS).

According to another aspect of the present disclosure, provided is a power conversion system (PCS) efficiency control system including: an energy storage system (VIB ESS) including a vanadium ion battery; a power conversion system (PCS) connected to a power grid and the VIB ESS; and a power conversion unit operatively connected to the power conversion system (PCS), in which the power conversion unit performs a control so as to conduct power conversion according to a specific charging/discharging range of the VIB ESS so as to satisfy an optimal efficiency range of the power conversion system (PCS) by considering power efficiency.

According to another aspect of the present disclosure, provided is a control method of a power conversion unit, which includes using a power conversion unit that provides a control of transferring at least one of power of a power grid and power of an energy storage system (ESS) to an electric vehicle charging system and a management control to correspond to the optimal efficiency range with respect to the power conversion by controlling charging/discharging of the energy storage system (ESS) according to the charging speed of the electric vehicle, in which the power conversion unit performs a control the power conversion system (PCS) to perform the power conversion according to a specific charging/discharging range of the ESS so as to satisfy the optimal efficiency range of the power conversion unit connected to the ESS by considering power efficiency.

When exemplary embodiments of the present disclosure are implemented, an energy storage system assists power use of a charger to stabilize power supply of a grid, and as a result, the charger may provide a stable electric vehicle charging service.

When the exemplary embodiments of the present disclosure are implemented, a control may be provided to achieve power conversion according to a specific charging/discharging range of the VIB ESS so as to satisfy an optimal efficiency range of the power conversion system (PCS) by considering power efficiency.

The effects provided by the present disclosure are not limited to the aforementioned effect, and other effects, which are not mentioned herein, will be apparent to a person having ordinary skill in the art from the following description.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is a conceptual diagram illustrating a power supply configuration including a power grid, an energy storage system, and other electric devices according to an exemplary embodiment of the present disclosure;

FIG. 1B are graphical representations of outputs according to time at points A, B, and C of FIG. 1A according to an embodiment of the present disclosure;

FIG. 1C is a conceptual configuration diagram of a system according to exemplary embodiments of the present disclosure;

FIGS. 2A, 2B, and 2C are graphical representations respectively illustrating a charger output, an ESS output, and a state of charge (SoC) of an ESS according to exemplary embodiments of the present disclosure;

FIG. 3A is a conceptual diagram illustrating the energy storage system (ESS) adopting the lithium ion battery (LIB) and being supplied with the power from the power grid;

FIG. 3B is a conceptual diagram illustrating a case when the VIB includes the same PCS of FIG. 3A, and all other conditions are the same, but the VIB is adopted instead of the LIB;

FIG. 3C is a conceptual diagram illustrating a case when a PCS is the same as that of FIG. 3B, but has a higher specification;

FIG. 4A is a flowchart for describing a charging order (S4000) of the VIB battery according to at least one exemplary embodiment of the present disclosure;

FIG. 4B is a flowchart for describing a discharging order (S5000) of the VIB battery according to at least one exemplary embodiment of the present disclosure;

FIG. 5 is a conceptual diagram illustrating power supply configurations in which an energy storage system is disposed in a space and in which other electric devices are disposed according to an exemplary embodiment of the present disclosure;

FIG. 6 is a diagram illustrating a configuration in which the charger receives power from the energy storage system and a power distribution device according to an exemplary embodiment of the present disclosure;

FIG. 7 is a diagram illustrating a configuration of the energy storage system according to an exemplary embodiment of the present disclosure;

FIG. 8 is a flowchart illustrating a process in which a controller controls the energy storage system according to electric energy in a grid according to an exemplary embodiment of the present disclosure;

FIG. 9 is a conceptual diagram illustrating layouts and operations of the energy storage system and charger according to an exemplary embodiment of the present disclosure;

FIG. 10 is a conceptual diagram illustrating layouts and operations of the energy storage system and the charger according to another exemplary embodiment of the present disclosure;

FIG. 11 is a flowchart illustrating a process in which the energy storage system operates in response to a power use increase situation in the grid according to an exemplary embodiment of the present disclosure;

FIG. 12 is a diagram illustrating the configuration of the energy storage system according to another exemplary embodiment of the present disclosure;

FIG. 13 is a diagram illustrating a configuration of the charger according to an exemplary embodiment of the present disclosure;

FIG. 14 illustrates an operation state management range when a monitoring level is constituted by Levels 1 to 4 according to an exemplary embodiment of the present disclosure;

FIG. 15 exemplarily illustrates a system that supplies the power to the ESS and the power consumption region from the grid, controls information on consumable power obtained from the PMS of the ESS and power supplying to the power consumption region, and performs electric energy supplying including ESS charging/discharging management according to an exemplary embodiment of the present disclosure; and

FIG. 16 is a conceptual view illustrating cases 1, 2, and 3 in which charging/discharging of the ESS is made at high C-rate with respect to a specific load, and various cell deviations with respect to internal battery cells of the ESS according to an exemplary embodiment of the present disclosure.

### DETAILED DESCRIPTION OF THE EMBODIMENT

Advantages and features of the present disclosure, and methods for accomplishing the same will be more clearly understood from exemplary embodiments described in detail below with reference to the accompanying drawings. However, the present disclosure is not limited to the exemplary embodiments set forth below, and will be embodied in various different forms. The present exemplary embodiments are just for rendering the disclosure of the present disclosure complete and are set forth to provide a complete understanding of the scope of the invention to a person with ordinary skill in the technical field to which the present disclosure pertains, and the present disclosure will only be defined by the scope of the claims. Throughout this specification, the same reference numerals denote the same elements.

Further, in describing the present disclosure, a detailed description of known related configurations and functions may be omitted to avoid unnecessarily obscuring the subject matter of the present disclosure.

In describing the components of the present disclosure, terms including first, second, A, B, (a), (b), and the like may be used. These terms are just intended to distinguish the components from other components, and the terms do not limit the nature, sequence, order, number, or the like of the components. When it is disclosed that any component is “connected”, “coupled”, or “linked” to other components, it should be understood that the component may be directly connected or linked to other components, but another component may be “interposed” between respective components, or the respective components may be “connected”, “coupled”, or “linked” via another component.

Hereinafter, in the present specification, technology in which an energy storage system installed in a space such as a building or a house, a subway, a public space, etc., controls charging or discharging of the energy storage system according to an electricity use situation of other electric devices in the space will be described. Further, technology in which the energy storage system controls a charger according to the electricity use situation will be described. In addition, technology in which when power use loads of other electric devices in the space increase, the energy storage system supplies power to the other electric devices will be described.

In general, the energy storage system (ESS) is constituted by a battery, a battery management system (BMS), a power conversion system (PCS), an energy management system (EMS), etc. The battery includes one or more cells, and a plurality of cells may constitute one module, and a plurality of modules may form one rack. The energy storage system (ESS) configured as such is connected to a power network, an electricity network, a power grid, etc., to receive the power.

The energy storage system (ESS) may be used for charging the electric vehicle (EV). Here, there are states-of-charge (SoCs) in a battery applied to the energy storage system (ESS) and a battery applied to the inside of the electric vehicle (EV), respectively, and a background thereof is described as below.

First, a charging/discharging rate (C-rate) of the battery should be appreciated. A charging rate of the battery and/or a discharging rate of the battery may be controlled by the charging/discharging rate (C-rate). The charging/discharging rate (C-rate) means measurement of current used for charging and/or discharging the battery. As an example, charging a specific battery at 1 C-rate or 1 C means that a battery having a capacity of 10 Ah (i.e., an amount when current of 10 ampere (A) flows for 1 hour) may discharge 10 ampere (A) for 1 hour while the battery is completely charged. In this way, the charging rate of the battery may also be represented by C-rate.

When a battery charged with a specific C-rate is measured, the corresponding state of charge (SoC) may be confirmed. Various controls for the charging may be performed by confirming SoC of an internal battery of the energy storage system (ESS), SoC of an internal battery of the electric vehicle (EV), and the like when charging an electric vehicle (EV) by using the energy storage system (ESS).

Exemplary embodiments of the present disclosure to be described below relate to a system control required for charging the electric vehicle (EV) by using the integrated system that applies the charger of the electric vehicle (EV) to the energy storage system (ESS), and the present inventors provides the system control by considering features technically improved as compared with a conventional or existing system configuration and control of the energy storage system (ESS). The feature of the present disclosure may also be expressed as an electric vehicle charging system driven by linking ESS power.

Hereinafter, the feature of the present disclosure will be described in more detail with reference to the exemplary embodiments.

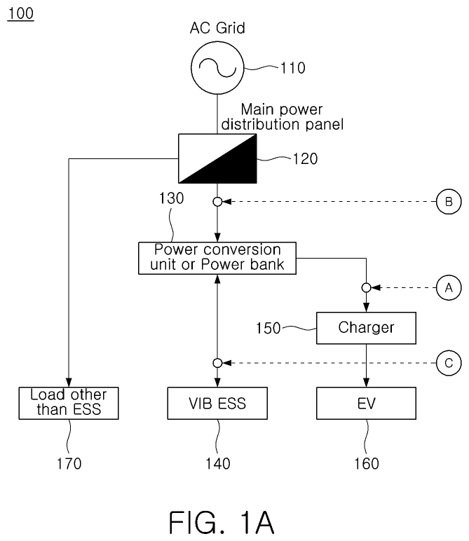

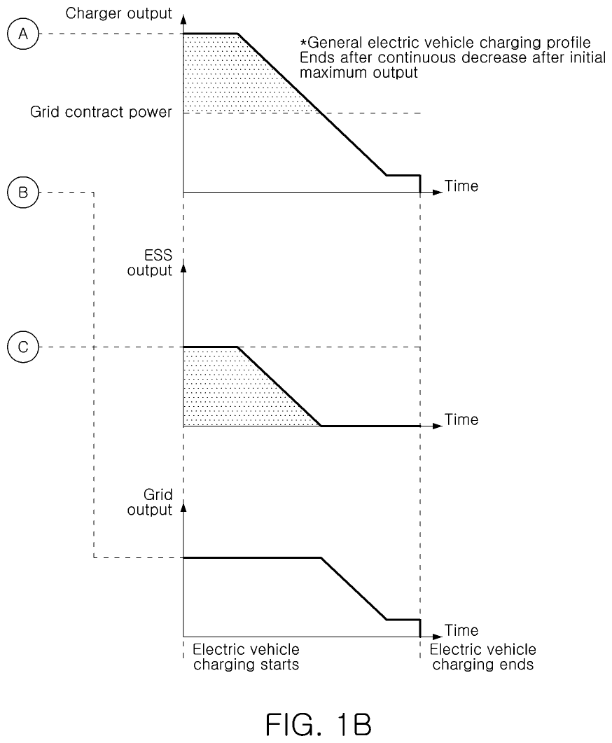

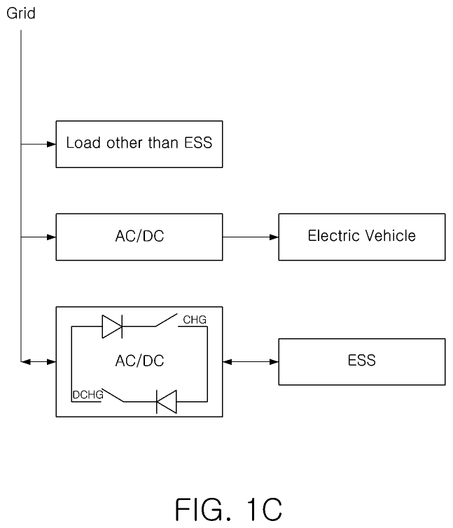

FIG. 1A is a conceptual diagram illustrating a power supply configuration including a power grid 110, an energy storage system 140, and other electric devices 120, 130, 150, 160, and 170 in a power supply system 100 according to an exemplary embodiment of the present disclosure.

In general, the power supply system 100 includes a main distribution panel 120 receiving power, i.e., alternating current (AC) from the power grid 110, and the corresponding power is distributed and provided to the power conversion system (PCS), a power bank, or a similar power conversion equipment 130. Meanwhile, the main distribution panel 120 is connected even to a load 170 other than the ESS to supply the power.

The power conversion equipment 130 may be operatively connected to the energy storage system 140 such as a VIB ESS, and provides a required control to transfer or receive the power. Further, the power conversion equipment 130 may be connected to the charger 150, and the charger 150 may be connected to the electric vehicle (EV) 160 or other objects requiring charging. The electric vehicle (EV) 160 may selectively receive at least one of the power provided by the power grid 110 and the power provided by the energy storage system 140 under the control of the power conversion equipment 130.

Here, at least one of the main distribution panel 120, the power conversion equipment 130, the energy storage system 140, the charger 150, the electric vehicle (EV) 160, and a load 170 other than the ESS may be installed inside or next to a designated place, e.g., a specific building.

The power supply system 100 is preferably installed and controlled to supply grid power to a specific building, and also additionally perform electric vehicle charging together. Therefore, outputs for portions marked A, B, and C in FIG. 1A will be described in more detail in FIG. 1B.

FIG. 1B are graphical representations of outputs according to time at points A, B, and C of FIG. 1A.

FIGS. 1A and 1B which illustrate a configuration in which the ESS and the charger are combined, correspond to technology that assists with the ESS and charges the ESS after charging ends so as not to exceed contract power of the grid.

A graph of output A shows a charger output over time, and the electric vehicle is charged while receiving the power from the grid and the ESS. A maximum output is shown at a beginning phase and an initial phase of the electric vehicle charging, and the output of the charger is lowered over time, and when the termination of the electric vehicle charging is approached, the output may reach a lowest level. The contract power related to the grid is exemplarily expressed as a certain level, and hereinafter, the contract power will be described in more detail.

A graph of output B shows a grid output over time, and the maximum output is shown at the beginning phase and the initial phase of the electric vehicle charging, and the output of the charger is lowered over time, and when the termination of the electric vehicle charging is approached, the output may reach the lowest level.

A graph of output C shows an ESS output over time, and the maximum output is shown at the beginning phase and the initial phase of the electric vehicle charging, and the output of the charger is lowered over time, and when the termination of the electric vehicle charging is approached, the output may reach the lowest level. Here, the maximum output of the ESS is a value acquired by subtracting the contract power of the grid from the maximum output of the charger.

FIG. 1C is a conceptual configuration diagram according to exemplary embodiments of the present disclosure.

The power is provided from the power grid for the electric vehicle charging, and supplied to the charger for the electric vehicle after AC/DC conversion. When the energy storage system (ESS) assists the power of the grid, and performs charging and discharging, a switching circuit is included in an AC/DC conversion unit, so it is possible to switch discharging and charging of the energy storage system during an electric vehicle charging procedure.

Therefore, exemplary embodiments of the present disclosure may provide a method for electric vehicle charging, in which a charging procedure is performed through the charger by receiving the power of at least one of the power grid and the energy storage system, and the discharging and the charging of the energy storage system are enabled to be switched according to the state of the power grid during the electric vehicle charging procedure.

Subsequently, a relationship between the output of the charger, and the output and the state-of-charge (SoC) of the ESS will be described in more detail.

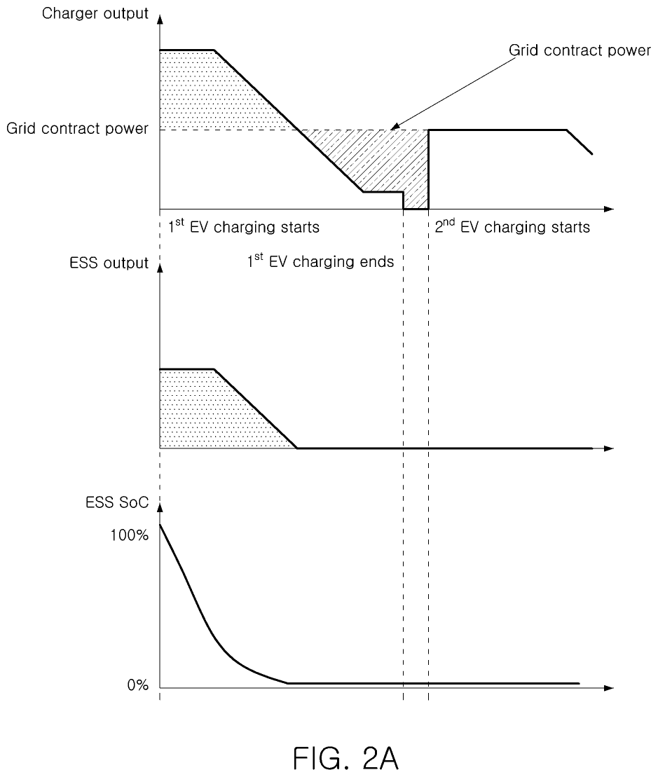

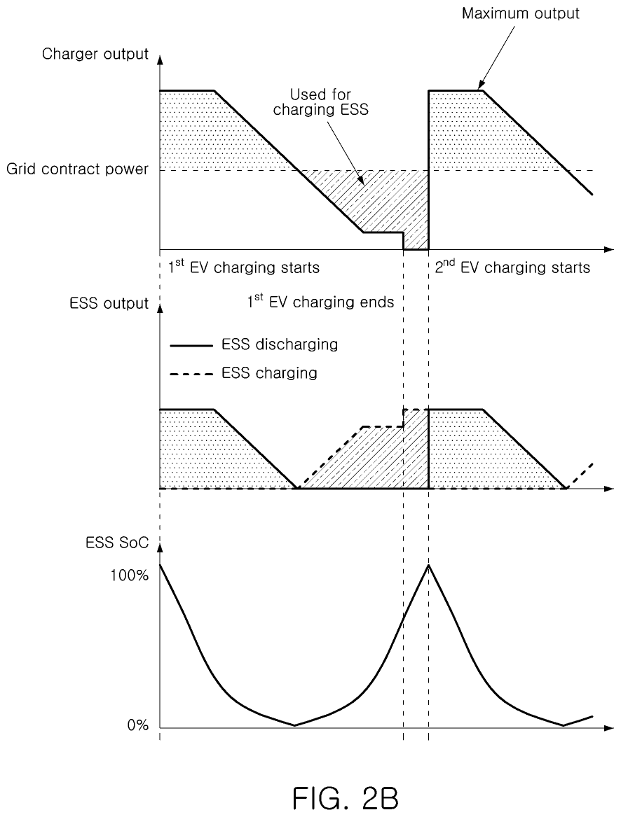

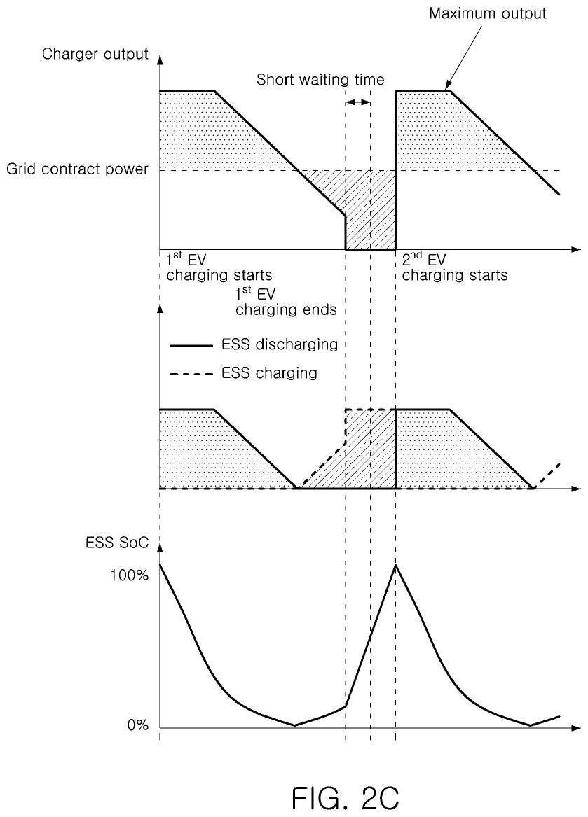

FIG. 2A is a conceptual diagram for the relationship between the output of the charger, the ESS output, and the state-of-charge (SoC) of the ESS according to a first exemplary embodiment of the present disclosure.

The description of FIGS. 1A to 1C pertain to a case where a charger outputs exceeding the contract power of the grid is required, for example, when starting the charging of a first electric vehicle. Thus, the electric vehicle is first charged with the ESS output. The output of the charger is lowered by continuous discharge of the ESS over time, and the charging is subsequently performed with the power of the grid, up to a charging termination time of the first EV during an interval of the grid contract power or less. Thereafter, charging of a second EV is intended to be immediately performed, the charging of the second EV may not be immediately used by the discharge of the ESS. That is, as can be seen from measurement of the SoC of the ESS, the SoC reaches a state of almost 0% at the first EV charging termination time.

When the EV charging is started in a state in which the ESS is fully charged, it is possible to charge the EV with the maximum output by assistance by the ESS. When a capacity of the ESS is similar to electric energy that assists the EV, it may be difficult to assist a second EV after charging one EV. The capacity of the ESS may be increased in order to solve this problem, but there is a problem in that overall cost is increased, and profitability is lowered. As another method, the ESS may be charged again, but there is a problem in that the number of charging EVs is reduced for a waiting time during recharging, and the profitability is lowered.

On the other hand, during the second half of the first EV charging, it can be seen that there is an area where the contract power of the grid is wasted. Therefore, the inventors of the present disclosure recognize a problem for the waste area, and research and develop a technical method capable of improving the problem.

FIG. 2B is a conceptual diagram for a relationship between the output of the charger, ESS output, and the state-of-charge of the ESS according to additional exemplary embodiments of the present disclosure.

In order to describe the background, a lithium ion battery (LIB) used currently used for the electric vehicle is enabled to be rapidly charged in a low SoC due to electrochemical characteristics, but when the SoC is raised up to a predetermined level or more, the lithium ion battery (LIB) is charged by lowering a speed of a safety reason. Even though the super fast (or ultra-fast) charger is applied, super fast charging is performed only during an initial interval, and a low-speed charging mode is reached after a predetermined period, and there is a regret for an EV charging process. That is, the ESS assisting the power grid should preferably supply optimal power according to an electric energy required by the electric vehicle, and it can be seen that a vanadium ion battery (VIB) having a wide charging/discharging (C-rate) coverage (available range) is a battery optimized for the ESS.

Therefore, the present inventors have developed a charging system in which the ESS is simultaneously charged and discharged during the electric vehicle charging. That is, a system is devised, in which the ESS discharging occurs to assist the power of the power grid in the electric vehicle fast charging interval, and then the ESS is charged according to the state of the power grid when entering the electric vehicle low-speed charging interval. Consequently, the system may be referred to as a system in which the difference between the SoC of the ESS when starting the electric vehicle charging and the SoC of the ESS after terminating the electric vehicle charging is less than or equal to a predetermined value.

Further, the present inventors have known that since a change in discharging/discharging output is large according to the state of the power grid, the VIB ESS is appropriate which is possible to respond to both the low output and the high output.

The present inventors propose that the system is to be used for charging the VIB ESS with respect to the area where the contract power of the grid is wasted illustrated in FIG. 2A.

Here, charging may be made with respect to at least one battery, at least one cell, at least one module, and/or at least one rack in the VIB ESS.

First, when the electric vehicle charging continuously occurs, if the charger output is lowered below a reference value, e.g., the contract power (of the power grid), a remaining surplus output may be used for charging the ESS. When a required control is performed herein, the SoC of the ESS is not changed until the second EV is charged after the first EV charging is terminated. That is, the present inventors have devised a charging system in which both the charging and the discharging of the ESS are performed during an electric vehicle charging process so as to supply the grid power to a specific building and also additionally charge the electric vehicle so that an EV user may continuously use a best-state charger.

Since a cycle of full charging and discharging per EV occurs in the ESS at this time, a VIB having a long lifespan is advantageous. Even though a charger operator uses an ESS having approximately half the capacity of one EV, the charger operator may also maintain a maximum charging speed.

FIG. 2C is a conceptual diagram for another relationship between the output of the charger, ESS output, and the state-of-charge (SoC) of the ESS according to additional exemplary embodiments of the present disclosure.

When the electric vehicle charging is interrupted, some of the EV users may stop charging and operate the EV if the electric vehicle charging speed falls to a predetermined value or less. Therefore, there may be a need for securing some charging time of the ESS or also a need for lowering the maximum output to a predetermined level while securing the charging time of the ESS.

This is represented as an area of a short waiting time in FIG. 2C, and represents a relationship between the charger output, the ESS output, and the ESS SoC.

When the electric vehicle charging is terminated before a reference value for switching from the discharging to the charging of the ESS, a control of resuming super fast (or ultra-fast) charging is performed after securing the charging time of the ESS for a predetermined time.

Alternatively, when the electric vehicle charging is terminated and the super fast charging is immediately conducted before the reference value for switching from the discharging to the charging of the ESS is reached, a control of adjusting electric vehicle super fast charging power downward is performed. For example, the control may also be executed when it is difficult to discharge the ESS.

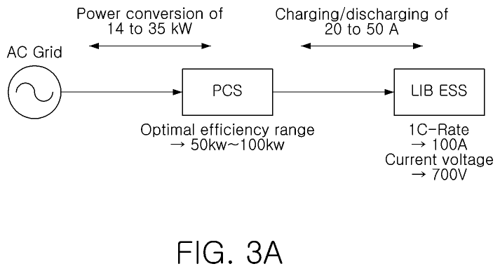

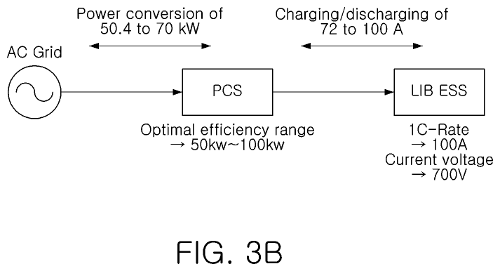

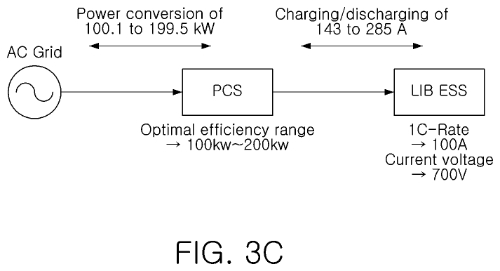

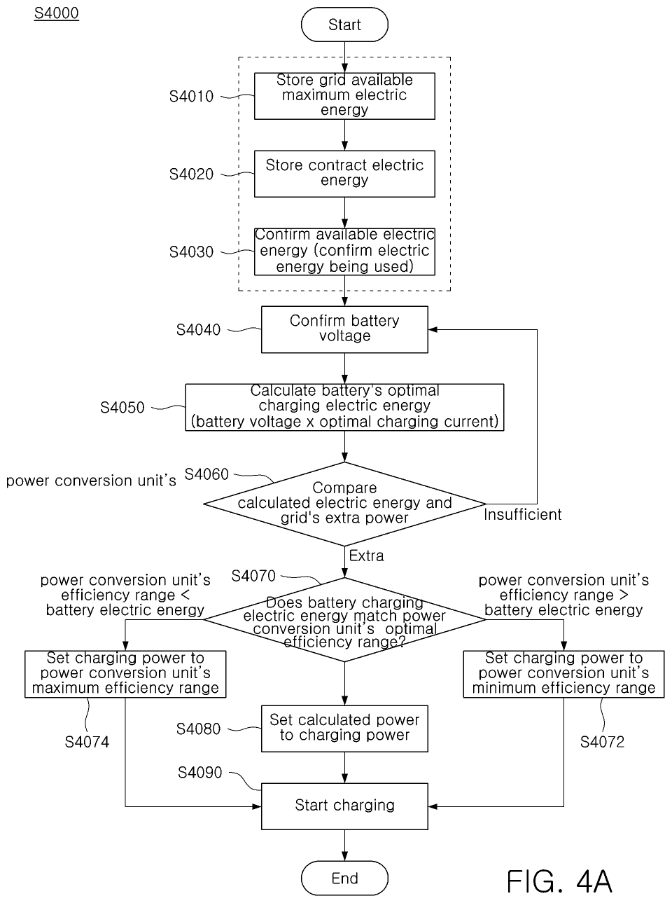

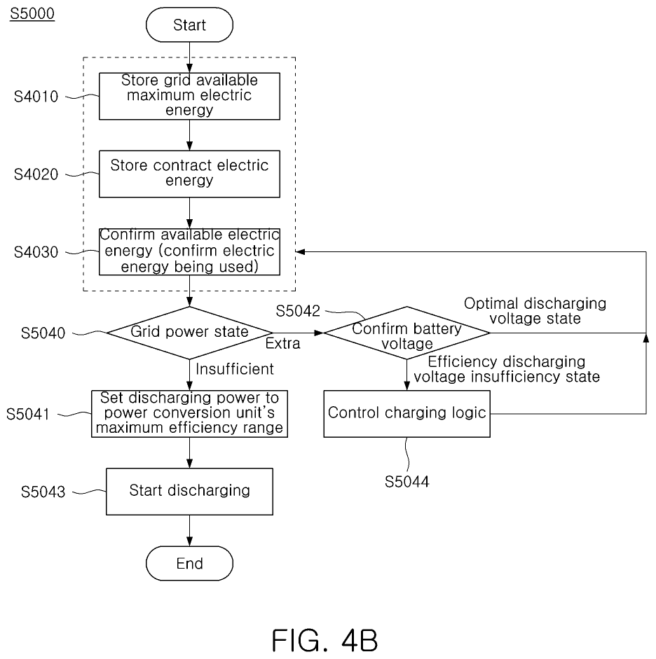

Next, additional exemplary embodiments of the present disclosure will be described in more detail with reference to FIGS. 3A, 3B, 3C, 4A, and 4B.

The battery management system or the battery control system has efficiency for the battery itself and efficiency for the power conversion unit. The battery efficiency means efficiency for an output compared with an input of the battery. More specifically, the battery efficiency means efficiency for a dischargeable amount as compared with a charge amount of the battery. The efficiency of the power conversion unit is better as the output power is higher in the case of an AC/DC converter, and better as DC voltage is higher in the case of a DC/AC inverter.

Here, in an AC/DC converter operation, a switching control is performed, and the power control is possible according to the switching speed. Upon outputting low power, the switching speed is low and upon outputting high power, the switching speed is high. Therefore, power of a predetermined level or more should be used in order to control the efficiency of the power conversion unit.

Therefore, battery voltage of a predetermined level or more should be used in order to control the efficiency of the power conversion unit.

However, the power conversion unit in the related art has an efficiency problem, and power loss and waste are excessive. In particular, the inventors of the present disclosure recognize a specific problem in that the power loss further increases upon outputting the low power, and a loss ratio is excessive by a management scheme of the battery management system in the related art, which does not consider the power efficiency due to an output limit according to a battery state (or performance). Based on the recognition of the problem, technology is conceived, which may manage the system for the power conversion unit by utilizing the optimal efficiency range jointly with solving the problem in the related art when managing the system by a more enhanced control and/a more improved scheme than the related art by applying a vanadium ion battery (VIB) researched and developed by the present inventors to the battery management system.

The vanadium ion battery (VIB) is better in terms of all of an output range, stability, and an available charging/discharging rate (c-rate) range than a lithium ion battery (LIB).

In the case of the vanadium ion battery, there is an experimental measurement result that efficiency between 0.2 C to 1.0 C is currently best. That is, the efficiency in the range of C to 1.0 C is relatively better than a case where the efficiency is 0.2 C or less and a case where the efficiency is 1.0 C or more. The corresponding range is exemplary, and efficiency between 0.2 C and 10 C, which has a wider range may also be regarded as a feature of the present disclosure. Further, an optimal efficiency range of the vanadium ion battery may also vary depending on technological development. A so-called high C-rate input/output is also sufficiently possible in the vanadium ion battery, but it may also be preferable to manage the vanadium ion battery at optimal efficiency.

It may be regarded that the related art conducts a charging/discharging control not considering the power efficiency by performing the charging/discharging control mainly based on the battery performance. On the contrary, in the present disclosure, a particular control for a process of charging the battery with voltage at a predetermined level or more and waiting is performed for more efficient battery discharging. Further, the present inventors develop battery technology that charges the battery with an optimal electric energy according to a specification of the power conversion unit for efficient battery charging, and more specifically, in some exemplary embodiments, when vanadium ion battery (VIB) is charged with a value between 0.2 C and 1.0 C, efficiency maximization is possible.

Hereinafter, referring to FIGS. 3A to 3C, the efficiency control of the power conversion unit will be additionally described as compared with a case of an energy storage system (ESS) adopting the lithium ion battery (LIB) and an energy storage system (ESS) adopting the vanadium ion battery (VIB).

FIG. 3A illustrates a conceptual view in which the energy storage system (ESS) adopting the lithium ion battery (LIB) and being supplied with the power from the power grid through the power conversion system (PCS). As an example, with respect to power supplied from an AC grid, as power conversion in a range of 14 kW to 35 kW is made by the power conversion system (PCS), the LIB ESS is capable of charging/discharging a range of 20 A to 50 A.

As characteristics of the lithium ion battery (LIB) adopting the LIB ESS, a battery optimal efficiency range of 0.2 C to 0.5 C may be provided. This range corresponds to a stable range of the LIB with a 1 C-rate of 100 A and a voltage of 700 V. The power conversion system (PCS) connected to the LIB ESS includes the power conversion unit, and the power conversion unit may perform the optimal efficiency control, and theoretically control charging/discharging in the range of 20 A to 50 A to be performed based on the battery, and also theoretically control power conversion in the range of 14 kW to 35 kW to be made. As a result, it may be regarded that the optimal efficiency range of the power conversion system (PCS) has a range of 50 kW to 100 kW.

However, in the case of the LIB, since a power conversion amount is determined according to the performance of the lithium battery, the efficiency control of the power conversion unit is actually impossible. Therefore, the power conversion unit may not satisfy the optimal efficiency, and as a result, the power loss cannot but be generated.

FIG. 3B illustrates a conceptual view when the VIB includes the same power conversion unit of FIG. 3A, and all other conditions are the same, but the VIB is adopted instead of the LIB. The VIB has a wider optimal efficiency range than the LIB due to electrochemical characteristics, and has a range of 0.2 C to 1 C. The 1 C-rate is 100 A and the current voltage is 700 V, and as a result, the VIB has the same values as the LIB. Further, the optimal efficiency range of the power conversion system (PCS) has the range of 50 kW to 100 kW by applying the same power conversion system (PCS).

However, unlike the LIB, the power conversion system (PCS) connected to the VIB ESS includes the power conversion unit, and the power conversion unit may perform the optimal efficiency control, and control charging/discharging in the range of approximately 70 A to 100 A to be performed based on the battery, and also theoretically control power conversion in the range of approximately 50 kW to 80 kW to be made to satisfy the optimal efficiency range (50 kW to 100 kW) of the power conversion system (PCS). The reason is that when the voltage of the ESS is higher upon discharging the VIB, the power conversion is possible with higher efficiency.

FIG. 3C illustrates a conceptual view when a power conversion system (PCS) which is the same as that of FIG. 3B, but has a higher specification is applied. As a result, the battery optimal efficiency range (0.2 C to 1 C), the 1 C-rate (100 A), and the current voltage (700 V) in FIG. 3B are the same, but the optimal efficiency range of the PCS has a wider range as 100 kW to 200 kW.

Therefore, the power conversion unit of the PCS connected to the VIB ESS may control charging/discharging in a range of approximately 140 A to 290 A to be performed based on the battery, and control power conversion in a range of 100 kW to 200 kW to be made to satisfy the optimal efficiency range (100 kW to 200 kW) of the high-specification PCS.

Here, a range of 0.2 C to 1 C, which is the battery optimal efficiency range of the VIB, is better. It is possible to use the VIB even in a range greater than or equal to 0.2 C to 1 C due to the electrochemical characteristics of the VIB. It may be regarded that the efficiency of the output as compared with the input of the VIB is best between 0.2 C to 1 C, but it does not mean that the efficiency is low in 0.2 C or less or 1 C or more. Even though the PCS provides any type of output, the VIB is enabled to stably operate, and the VIB has higher efficiency than the power loss of the PCS, so the charge electric energy may be controlled by giving a priority to the PCS power conversion efficiency. That is, the power conversion amount is not determined according to the performance of the applied battery, but the power conversion unit (and/or the PCS) is prioritized to be managed in the optimal efficiency range, and it is possible to efficiently control the power conversion unit (and/or the PCS) unlike the case of the LIB.

Accordingly, when the feature of the present disclosure is used, operation in the optimal efficiency range of the PCS is made possible, and hereinafter, a charging order and a discharging order of the VIB battery will be described.

FIG. 4A is a flowchart for describing a charging order (S4000) of the VIB battery according to at least one exemplary embodiment of the present disclosure.

First, steps S4010 to S4030 marked with dotted lines may be performed when it is assumed that the grid power is extra. That is, a grid's available maximum electric energy is stored (S4010), a contract electric energy is stored (S4020), and an available electric energy or an electric energy which is being used is confirmed (S4030). Here, various electric energies may be confirmed by using a surveillance or monitoring means, a device, a sensor, a measurer, an instrument, etc., and the corresponding electric energy may be stored in a storage means such as a memory, a storage device, etc.

In general, the voltage of the battery is first confirmed (S4040). Next, a battery optimal charging electric energy calculation (battery voltage X optimal charging current) is performed (S4050). Thereafter, the calculated electric energy and grid's extract power are compared (S4060). When the grid's extra power is insufficient, the process may return to the battery's voltage confirming step (S4040) again, and also wait until the grid's extra power is generated.

Thereafter, it is judged whether the battery charging electric energy matches the optimal efficiency range of the PCS (S4070), the charging power is set with the calculated power (S4080), and charging starts (S4090).

When it is judged that the PCS efficiency range is larger than the battery electric energy in the matching judgment step (S4070) described above, the charging power is set with the PCS's minimum efficiency range (S4072) and the charging starts (S4090). Alternatively, when it is judged that the PCS efficiency range is smaller than the battery electric energy, the charging power is set with the PCS's maximum efficiency range (S4074) and the charging starts (S4090).

The charging process of the VIB battery may be conducted according to the VIB battery optimal efficiency range, the PCS's optimal efficiency range, and the like in FIG. 3B or 3C described above according to FIG. 4A.

FIG. 4B is a flowchart for describing a discharging order (S5000) of the VIB battery according to at least one exemplary embodiment of the present disclosure.

First, steps S5010 to S5030 marked with dotted lines may be performed when it is assumed that the grid power is extra. That is, a grid's available maximum electric energy is stored (S5010), a contract electric energy is stored (S5020), and an available electric energy or an electric energy which is being used is confirmed (S5030). Here, various electric energies may be confirmed by using a surveillance or monitoring means, a device, a sensor, a measurer, an instrument, etc., and the corresponding electric energy may be stored in a storage means such as a memory, etc.

In general, the power state of the grid is first confirmed (S5040). When it is confirmed that the grid power is insufficient, discharging power is set with the PCS's maximum efficiency range (S5041) and battery discharging starts (S5043).

On the contrary, when it is confirmed that the grid power is extra, the voltage of the battery is confirmed (S5042). When it is judged that the grid power is in an optimal discharge voltage state, the process returns to the step (S5030) of confirming the available electric energy or the electric energy which is being used, and the confirmation of the power state of the grid (S5040) is performed again. On the contrary, when it is judged that the efficiency discharge voltage is insufficient, a charging logic control is performed(S5044).

Consequently, when the grid electric energy is insufficient, the discharging is conducted in the maximum efficiency range of the power conversion unit (i.e., PCS), and when the grid electric energy is extra and the battery voltage is not optimal discharging voltage, a charging logic is performed. Therefore, since a preparation is made by further increasing the voltage of the battery even a little, it is possible to conduct optimal-efficiency power conversion.

The discharging process of the VIB battery may be conducted according to the VIB battery optimal efficiency range and the PCS's optimal efficiency range in FIG. 3A or 3B described above according to FIG. 4B.

In the contents and related description of FIGS. 3A, 3B, 3C, 4A, and 4B described above, the surveillance or monitoring means, devices, sensors, measurers, instruments, power meters, etc., may be used for confirmation, and comparison and judgment of various electric energies, and wired communication or wireless communication equipment and technology such as wi-fi may be utilized for transmitting and receiving the electric energy information.

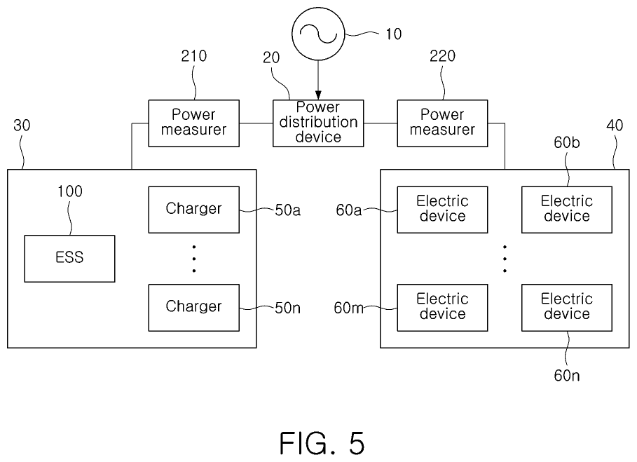

FIG. 5 is a conceptual diagram illustrating power supply configurations in which an energy storage system is disposed in a space and in which other electric devices are disposed according to an exemplary embodiment of the present disclosure. In FIG. 5, the grid corresponding to the power source 10 may supply the power to a supportive power region 30 and a primary power region 40. The energy storage system (ESS) 100 may be disposed in the supportive power region 30.

The energy storage system (ESS) 100 and one or more chargers 50a to 50n may be disposed in the supportive power region 30. Multiple electric devices 60a to 60n may be disposed in the primary power region 40. Further, a separate ESS distinguished from the energy storage system 100 disposed in the supportive power region 30 may be disposed in the primary power region 40.

In the exemplary embodiment of FIG. 5, the power distribution device 20 may distribute the power to the supportive power region 30 and the primary power region 40. The energy storage system 100 may charge or discharge according to an electricity demand or an expected demand used in two regions 30 and 40. To this end, a power measurer 210 may be connected to or disposed inside the supportive power region 30. Further, a power measurer 220 may be connected to or disposed inside the primary power region 40.

The power measurers 210 and 220 which are electric level instrument (electric level meter) as an exemplary embodiment measure electric levels which are used in regions where the power measurers 210 and 220 are installed. The power measurers 210 and 220 transmit measured values (electric levels) to the energy storage system 100. Further, according to an exemplary embodiment of the present disclosure, a separate power measurer may also be disposed in the power source 10. In this case, the energy storage system 100 may confirm a magnitude of consumed power of the power source 10 in real time.

In this specification, the energy storage system includes an energy storage system including a vanadium ion battery, but the present disclosure is not limited thereto. For example, the energy storage system of the present disclosure may include a vanadium redox battery (VRB), a polysulfide bromide battery (PSB), zinc bromine battery (ZBB), or the like. When the exemplary embodiment of FIG. 5 is applied, if the charger 50 charges the electric vehicle or another device which needs to be charged, the charger 50 may perform charging according to a charging condition required by the electric vehicle or other devices. For example, when high-current charging is requested, the charger 50 performs the high-current charging. The powers of the power source 10 and the energy storage system 100 are provided to the charger 50 according to the control of the energy storage system 100. In addition, when the charger 50 performs low-current charging, the charger 50 is supplied with the power from the power source 10 to charge the electric vehicle or other devices according to a power supply situation of the power source 10 or a power use situation of the primary power region 40 in the energy storage system 100.

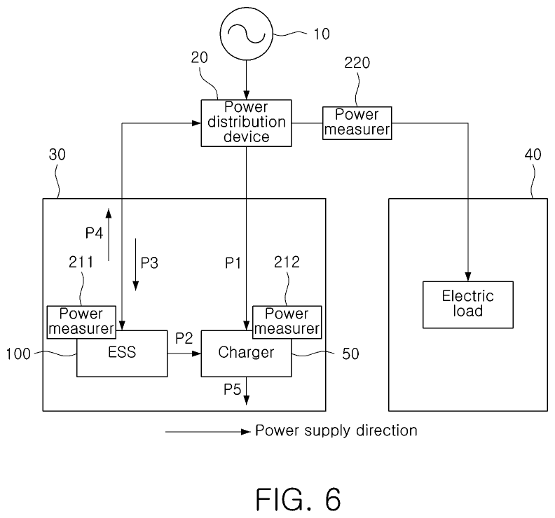

FIG. 6 is a diagram illustrating a configuration in which the charger receives power from the energy storage system 100 and a power distribution device 20 according to an exemplary embodiment of the present disclosure.

The charger 50 may be supplied with the power from the power distribution device 20 (P1). An exemplary embodiment thereof is being supplied with the power from the grid, i.e., the power source 10. In addition, the energy storage system 100 compares information on the electric energies received from the power measurers 211, 212, and 220 and the maximum electric energy providable by the power source 10 to assist a part or the entirety of the electric energy to be used by the charger 50.

The energy storage system 100 may supply the power to the charger 50 (P2). The charger 50 may switch or merge the supplied power according to the control of the energy storage system 100. The charger 50 may supply the power according to a charging request of an external device (P5).

The energy storage system 100 may be supplied with the power from the power distribution device 20 (P3). In addition, the energy storage system 100 may supply the power to the primary power region 40 (P4). The power supplied by the energy storage system 100 may be supplied to the primary power region 40 via the power distribution device 20. That is, a power supply direction between the energy storage system 100 and the power distribution device 20 may be bidirectional.

The power supply of the energy storage system 100 (P4) may be determined by the power demand of the primary power region 40, the maximum electric energy which may be provided by the power source 10, etc.

When the energy storage system 100 supports fast (or ultra-fast) charging and discharging functions of the charger 50, the energy storage system 100 monitors the electric energy of the grid 10 to flexibly respond to the power situation of the grid 10. In particular, the energy storage system 100 may predict a time zone in which a power usage amount of the grid 10 is low by accumulatively storing information for a past power usage time of the grid 10. As a result, the energy storage system 100 may prepare for a case where power usage of the grid 10 is to be rapidly increased during fast charging and discharging processes of the charger 50.

Moreover, even when fast charging of the energy storage system 100 is required, such a process may be applied. That is, the energy storage system 100 may conduct the fast charging of the energy storage system 100 by being supplied with the power of the grid 10. Even in this process, it is possible to flexibly respond to the power situation of the grid 10 by monitoring the electric energy of the grid 10 described above.

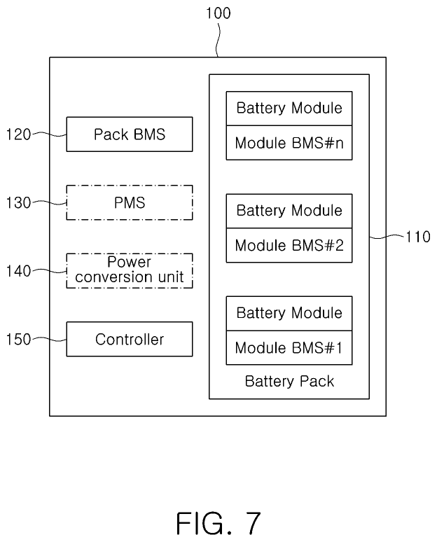

FIG. 7 is a diagram illustrating a configuration of the ESS according to an exemplary embodiment of the present disclosure. The energy storage system 100 includes an energy storage module 110 and a controller 150. The energy storage module 110 may include a battery.

The energy storage system 100 includes a pack BMS 120 that manages charging and discharging of the energy storage module 110. Further, the energy storage system 100 may selectively include a power management system (PMS) 130 and a power conversion system (PCS) 140. When the energy storage system 100 includes both the PMS 130 and the PCS 140, the energy storage system 100 may be referred to as an integrated ESS.

A module BMS manages the battery by monitoring a charging state, a discharging state, a temperature, a voltage, a current, etc., of the battery. The pack BMS 120 is a battery management system for an entire battery pack.

The controller 150 may determine charging or discharging of the energy storage module 110 by using a power measurement result of the supportive power region and the power measurement result of the primary power region, or determine whether to discharge power to one or more chargers disposed in the supportive power region or the primary power region. Further, according to an exemplary embodiment, the controller 150 is integrated with the PMS 130 to operate as one component.

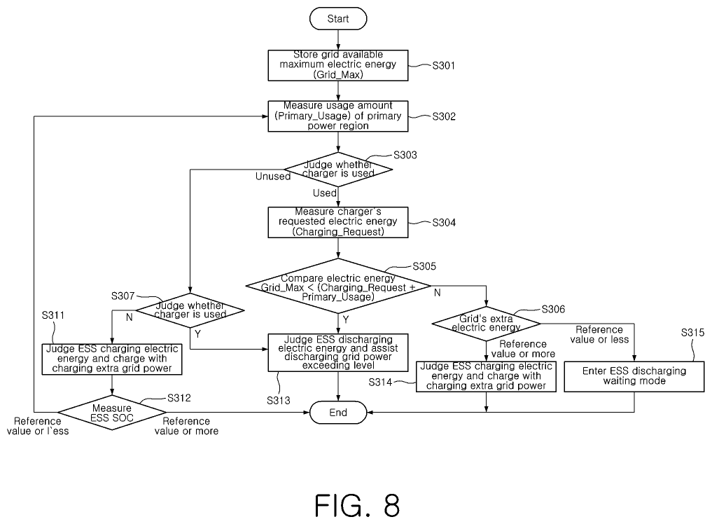

FIG. 8 is a diagram illustrating a process in which a controller controls the ESS according to electric energy in a grid according to an exemplary embodiment of the present disclosure.

The controller 150 may store a maximum electric energy Grid_Max of the grid for supplying the power to the primary power region and the supportive power region, i.e., the power source 10 (S301). The maximum electric energy Grid_Max means a maximum electric energy which may be used in the grid.

Thereafter, the power measurer 220 measures a power usage amount Primary_Usage of the primary power region 40 (S302). This measures the power usage amount (load usage amount) which is generated in a region other than the supportive power region 30 in which the energy storage system 100 is disposed as an exemplary embodiment.

Further, according to another exemplary embodiment of the present disclosure, in step S302, the energy storage system 100 or the controller 150 may receive a total power consumption of the grid and the power usage amount of the primary power region.

Next, the controller 150 judges whether the charger 50 disposed in the supportive power region 30 is used (S303). When there are multiple chargers 50, the controller 150 may judge whether each charger 50 is used. If the charger 50 is unused, the controller 150 proceeds to step S307. The controller 150 compares electric energies (S307), and compares Grid_Max and Primary_Usage, and when Grid_Max is greater than or equal to Primary_Usage, the controller 150 conducts charging by determining the ESS charging amount (S311).

In addition, the controller 150 measures a state of charge (SoC) of the ESS (S312), and terminates charging when the SoC is greater than or equal to a SoC reference value. Meanwhile, the controller 150 measures the SoC of the energy storage system 100 (S312) to control the charging of the ESS while repeating the process from S302 when the SoC is less than or equal to the SoC reference value.

Meanwhile, when Grid_Max is less than Primary_Usage in S307, the controller 150 judges a discharge electric energy of the energy storage system 100 to control the energy storage system 100 so that the energy storage system 100 discharges the power to the primary power region 40 (S313). As a result, a grid power exceeding level is assisted by the discharge of the energy storage system 100.

When the charger is being used in S303, the controller 150 measures a charger's requested electric energy Charging_Request (S304). In this case, it is assumed that the SoC of the ESS is greater than or equal to the reference value. In addition, the controller 150 compares the electric energies (S305), and compares Grid_Max with a sum (Charging_Request+Primary_Usage) of Charging_Request and Primary_Usage.

When Grid_Max is less than (Primary_Usage+Charging_Request) as a comparison result, the controller 150 judges the discharge electric energy of the energy storage system 100 to control the energy storage system 100 so that the energy storage system 100 discharges the power to the primary power region 40 (S313). As a result, the grid power exceeding level is assisted by the discharge of the energy storage system 100.

Further, when Grid_Max is greater than or equal to (Primary_Usage+Charging_Request) as the comparison result of S305, the controller 150 confirms whether a difference is greater than or equal to a grid extra reference value (S306). Here, the difference is extra electric energy of the grid, as expressed in Equation 1 below.

Extra electric energy of grid=Grid_Max−(Primary_Usage+Charging_Request) [Equation 1]

When the extra electric energy of the grid is greater than or equal to the grid extra reference value, the electric energy is sufficient, so the controller 150 judges a charging electric energy of the energy storage system 100 to control the energy storage system 100 so that the energy storage system 100 conducts charging (S314). This means that the energy storage system 100 conducts charging with the grid electric energy which is sufficiently extra.

On the contrary, when the extra electric energy of the grid is less than the grid extra reference value, there is a high possibility that the power demands of the supportive power region 30 and the primary power region 40 will not be satisfied with the electric energy of the grid afterwards, so the controller 150 makes the energy storage system 100 to enter a discharge waiting mode (S315).

In FIG. 8, in the steps of charging the ESS (S311 and S314), the controller 150 may perform a high current charging process of the battery. In addition, the controller 150 continuously receives an electric energy measurement result of the primary power region, and when the extra power of the grid is lowered, the controller 150 may charge the battery with low current or control the ESS to enter the discharge waiting model as in S315. Of course, even in the discharge waiting mode, the controller 150 monitors a total power situation of the grid and the SoC of the battery to determine whether low-power charging or high-current charging of the battery is conducted.

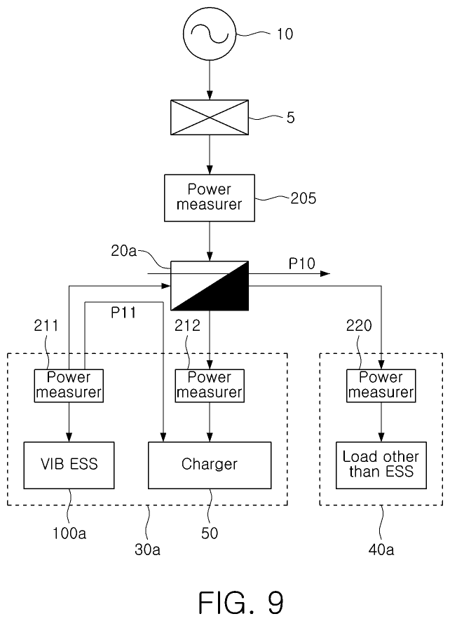

FIG. 9 is a diagram illustrating layouts and operations of the ESS and the charger according to an exemplary embodiment of the present disclosure. In FIG. 9, a vanadium ion battery ESS (VIB ESS) 100a, which is an exemplary embodiment of the ESS, is disposed. A supply process of electricity is in an order of the power source 10 as the grid, a substation 5, a power measurer 205, and a power distribution device 20a which has the main power distribution panel as an exemplary embodiment, and the electricity is supplied from the power distribution device 20a to the VIB ESS 100a, the charger, 50, and the load other than the ESS. The power measurer 205 may be disposed in a grid's main power line, and the power measurers 211, 212, and 220 may be disposed even in respective regions 30a and 40a for each line. Information on power consumption for each region and all regions is transmitted to the VIB ESS 100a.

As described in FIG. 8 above, the VIB ESS 100a stores information on the maximum electric energy Grid_Max which may be used by the grid. Further, the VIB ESS 100a may receive information on a supply electric energy (e.g., an electric energy being used in block 40a) of the load other than the ESS from the power measurer 220 disposed in primary power region 40a. Further, as an exemplary embodiment of the present disclosure, the VIB ESS 100a may receive the grid's total power consumption Grid_Usage from the power measurer 205.

As a reception scheme, either of periodic reception or real-time reception is available. In the periodic reception, the corresponding period may be changed according to a change in electric energy used in the primary power region 40a. For example, the controller 150 may set the reception period to 5 minutes at night when the change in electric energy is not almost changed, and set the reception period to 1 minute during the day when the change in electric energy is great.

The VIB ESS 100a may control charging or discharging of the VIB ESS 100a so as to optimize the power use of the grid according to the electric energy used in the primary power region 40a. A driving mode of the VIB ESS 100a includes a charging mode, a discharging mode, and a waiting mode. In the case of the charging mode, the VIB ESS 100a determines an ESS charging amount, and conducts charging according to the SoC reference value of the ESS, and terminates the charging mode.

Further, the VIB ESS 100a may also assist some or the entirety of the electric energy output by the charger 50 (P11). For example, when a value (available electric energy) acquired by subtracting the power usage amount of the primary power region 40a from the grid's maximum electric energy is less than the electric energy output by the charger 50 (a shortage level of the charging electric energy of the charger is generated), the VIB ESS 100a may assist an electric energy of the shortage level or an electric energy greater than or equal to the shortage level.

Further, when Grid_Usage is equal to Grid_Max or when the Grid_Usage is greater than Grid_Max, so the power of the grid is cut off, the VIB ESS 100a may discharge the charged electric energy to the primary power region 40a. For example, when the VIB ESS 100a discharges the electric energy to the power distribution device 20a as in P10, the power distribution device 20a may supply the power to the primary power region 40a.

Further, the VIB ESS 100a may also assist some or the entirety of the electric energy output by the charger 50 (P11). For example, when a value (available electric energy) acquired by subtracting the grid's total power consumption Grid_Usage from the grid's maximum electric energy is less than the electric energy output by the charger 50 (a shortage level of the charging electric energy of the charger is generated), the VIB ESS 100a may assist an electric energy of the shortage level or an electric energy greater than or equal to the shortage level.

When the exemplary embodiment of FIG. 9 is applied, the VIB ESS 100a may optimize the electric energy of the grid according to the power use situation in the grid. For example, the VIB ESS 100a assists the electric energy to minimize loss due to excessive power or peak power and suppress grid overload.

Accordingly, the controller 150 of the VIB ESS 100a may receive the electric energy measurement result of the primary power region, and then determine any one charging scheme of the high-current charging or the low-current charging of the battery. The electric energy of the primary power region is compared with the grid's total usage amount, and when the electric energy of the primary power region is less than or equal to a predetermined reference (e.g., 80% or less), the VIB ESS 100a may be rapidly charged through the high-current charging.

On the contrary, when the electric energy of the primary power region is compared with the grid's total usage amount, and when the electric energy of the primary power region is greater than the predetermined reference (e.g., more than 80%), the VIB ESS 100a is continuously charged through the low-current charging to lower the entire load of the grid and assist the grid power by using power charged afterwards.

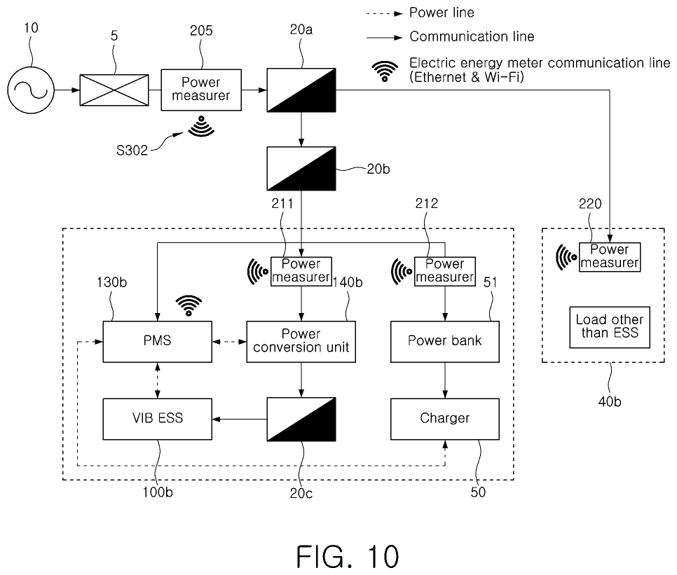

FIG. 10 is a diagram illustrating layouts and operations of the ESS and the charger according to another exemplary embodiment of the present disclosure. A configuration of FIG. 10 is an exemplary embodiment in which a power distribution device 20a serving as the main power distribution panel and the power distribution device 20b serving as an ESS power distribution panel are distinguished unlike FIG. 9. Moreover, the configuration of FIG. 10 is a configuration in which a power distribution device 20c serving as a DC power distribution panel (container) supplying the power to the VIB ESS 100b is separately disposed.

The power distribution device 20c may be configured to be divided into one or more elements, and the present disclosure is not limited to a specific configuration scheme of the power distribution device. The power distribution device 20c may be selectively disposed according to the configuration, the layout, and the like of the VIB ESS 100b.

In FIG. 10, the PMS 130b and the PCS 140b are separately represented, but the present disclosure is not limited thereto, and the PMS 130b and the PCS 140b may also be configured in the VIB ESS 100b. The PMS 130b is integrated with the controller 150 to control the driving mode such as the charging or the discharging of the VIB ESS 100b.

Further, a power bank 51 may also become a component of the charger 50 according to an implementation scheme of the present disclosure or an independent component from the charger 50. In the configuration of FIG. 9, the VIB ESS 100a may assist the total power of the grid. The VIB ESS 100b stores information on a maximum output amount of the power grid. In addition, the VIB ESS 100b may receive the grid's total power consumption from the power measurer 205. Alternatively, the VIB ESS 100b receives a measurement value of a usage amount of the load other than the ESS to judge a grid usable electric energy. The VIB ESS 100b receives information on the grid's total power consumption or receives the measurement value of the usage amount of the load other than the ESS to control the charging or the discharging of the VIB ESS 100b.

The load other than the ESS indicates a load for power use other than the VIB ESS 100b and the charger 50, and means a load in the primary power region 40b such as power use in a building, and power use in a home, a server, a subway, etc.

The information on the grid's maximum electric energy may be input into the VIB ESS 100b in advance, and when the grid's maximum electric energy is changed, the VIB ESS 100b stores a changed value. The input value may be stored in the ESS 100b, and maintained during a predetermined period. The VIB ESS 100b may store the information on the grid's maximum electric energy Grid_Max by a scheme such as 380 V AC/150 KW.

When the exemplary embodiment of FIG. 10 is applied, the grid such as the power source 10 supplies the power to the energy storage system 100b, the charger 50, and other loads (loads other than the ESS) other than the energy storage system and the charger. Further, the energy storage system 100b may include one or more power measurers 205, 211, 212, and 220 that measure the electric energies of the grid, the energy storage system 100b, the charger 50, and other loads (loads other than the ESS).

In addition, the controller of the energy storage system 100b may determine the charging or the discharging of the energy storage module by using any one or more of the electric energy of the grid or the electric energies of other loads measured by the power measurers 205, 211, 212, and 220, or determine to supply the power to the charger or other loads.

In the case of an exemplary embodiment in which the electric energy of the grid may be confirmed by the electric energies of other loads (loads other than the ESS), the energy storage system 100b may determine the charging or the discharging of the energy storage module by using the value measured by the power measurer 220 disposed in the load other than the ESS, or determine to supply the power to other loads.

Meanwhile, when the electric energy of the grid may not be confirmed by the electric energies of other loads, or it is necessary to confirm the electric energy of the grid in real time without an error, the energy storage system 100b may determine the charging or the discharging of the energy storage module by using the value measured by the power measurer 205 disposed in the power source 10, or determine to supply the power to the charger or other loads.

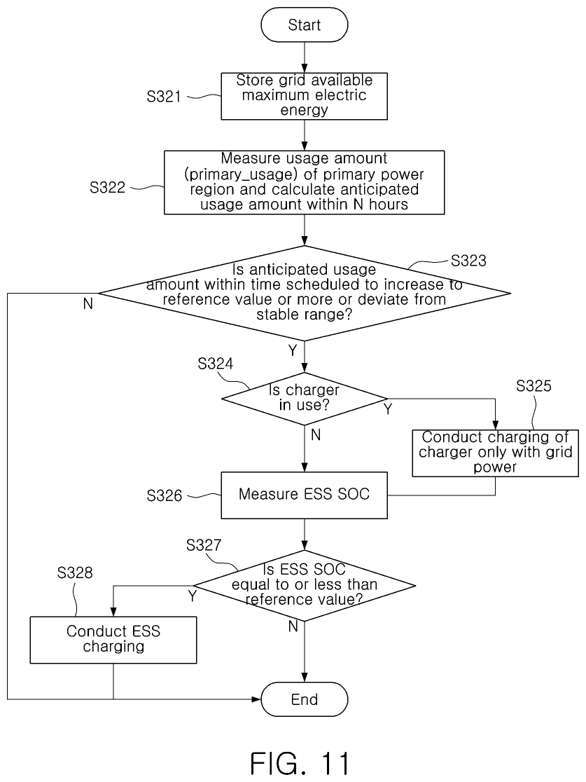

FIG. 11 is a diagram illustrating a process in which the ESS operates in response to a power use increase situation in the grid according to an exemplary embodiment of the present disclosure.

The controller 150 stores the maximum electric energy Grid_Max usable by the grid (S321). In this case, the power source 10 may provide information on the maximum electric energy to the controller 150. Alternatively, the maximum electric energy of the power source may be input into the controller 150 in advance.

Thereafter, the power measurer 220 measures a power usage amount Primary_Usage of the primary power region, and the controller 150 calculates an anticipated usage amount within N hours (S322). The controller 150 may accumulate and store information on the power usage amount Primary_Usage of the primary power region. The controller 150 monitors the power usage amount Primary_Usage of the primary power region in real time, and calculates the anticipated usage amount within N hours when the power usage amount increases.

In this case, the controller 150 may calculate the anticipated usage amount by reflecting seasonal factors. As an exemplary embodiment, the controller 150 may calculate the anticipated usage amount based on information (e.g., 2 p.m. to 4 p.m.) on a time zone for which an air conditioner is likely to be used in a corresponding space (the building, the home, etc.).

As a result, when the current power usage amount Primary_Usage of the primary power region belongs to a stable range or is less than or equal to a reference value, the controller 150 may judge whether the anticipated usage amount within N hours departs from the stable range or is more than the reference value (S323). In this case, the controller 150 conducts the waiting mode to assist the power usage amount Primary_Usage of the primary power region by preparing for the increase in power usage amount.

The controller 150 confirms whether the charger 50 is in use (S324). When the charger 50 is in use, the controller 150 may control the charging to be conducted only with the grid power (S325). This is to conserve the power charged in the energy storage system 100 so as to assist the power use of the primary power region.

Further, when the charger 50 is not in use or the charger 50 conducts charging only with the grid power, the controller 150 measures the SoC of the energy storage system 100 (S326). When the SoC of the energy storage system 100 is less than or equal to a reference value according to the measurement result (S327), the energy storage system 100 conducts charging (S328).

When the process of FIG. 11 is applied, if the power usage amount Primary_Usage of the primary power region increases, the energy storage system 100 may assist the power.

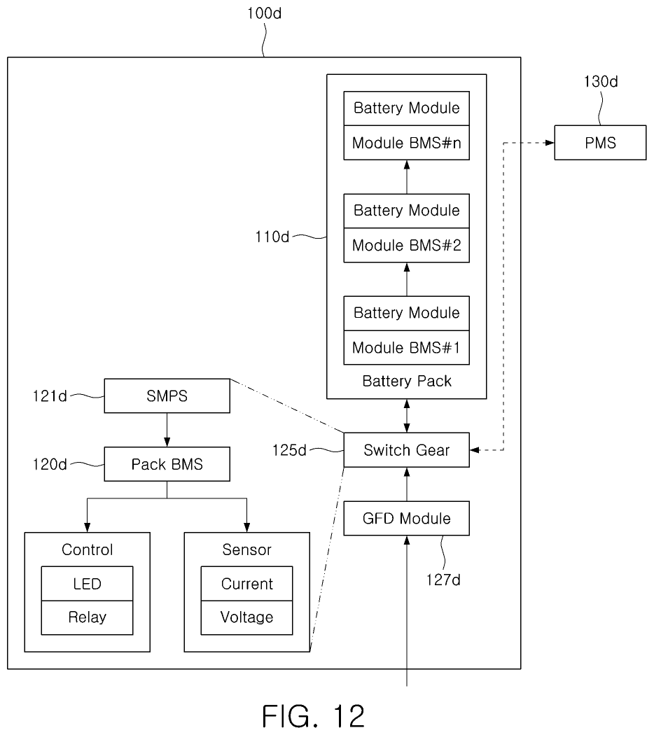

FIG. 12 is a diagram illustrating a configuration of the ESS according to another exemplary embodiment of the present disclosure. Power supplied from the outside is applied to a battery pack 110d via a ground fault device (GFD) 127d and a switch gear 125d. As a detailed configuration of the switch gear 125d, a switched-mode power supply (SMPS) 121d and a pack BMS 120d are used as an exemplary embodiment. The pack BMS 120d may perform control and sensing, control an LED and a relay, and sense current and voltage. In FIG. 12, the switch gear 125d and the PMS 130d may constitute the controller 150.

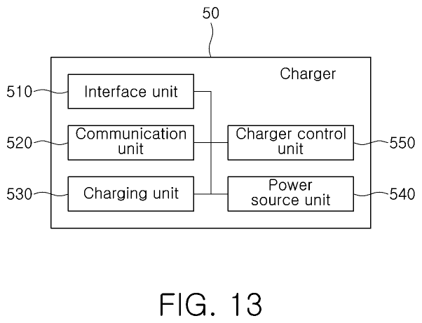

FIG. 13 is a diagram illustrating a configuration of the charger according to an exemplary embodiment of the present disclosure.

A charger control unit 550 controls an operation of the charger 50, and controls various components 510, 520, 530, and 540 constituting the charger 50.

An interface unit 510 provides an interface so that a user may input or confirm information in the process of charging various devices, including the electric vehicle, an electric bicycle, etc., from the charger 50. The interface unit 510 may be constituted by a touch screen, a button, and the like.

The communication unit 520 transmits and receives information to and from external devices. The communication unit 520 may receive, from the ESS 100 or the PMS 130, a current available power situation, information on whether the input power is input from the grid or the ESS, and the like. Further, the communication unit 520 may transmit, to the ESS 100, the PMS 130, or the like, information related to a situation in which the charger 50 currently conducts charging. Alternatively, the communication unit 520 may transmit, to another charger, information related to a situation in which charging is currently conducted.

A charging unit 530 charges other devices (the electric vehicle, the electric bicycle, an electronic product, etc.). A power source unit 540 is supplied with the power from the outside and provides the power to the charging unit 530.

The charger control unit 550 outputs, to the interface unit 510, a price, a time, an option, etc., which are related to the charging according to a source of the power supplied to the power source unit 540. The charger control unit 550 may control the charging unit 530 according to the source supplied to the power source unit 540, a charging option set by the interface unit 510, etc.

The charger control unit 550 determines a billing unit of a charged price or a charging time according to the type of supply source. The charging unit 530 conducts charging according to the time or price selected by the interface unit 510.

Some or all of the features of the present disclosure may be utilized in a battery charging management system in which a used power use history is analyzed which is generated in a process in which a user performs charging in the ESS or an electric vehicle charging station to enable billing as large as actually charged power, and analyze a power use state and confirm power loss. According to the exemplary embodiment of the present disclosure, the battery charging management system described above may include a means for determining a use or consumption history for the power transmitted from the ESS, and analyzing information on energy use or loss. The power use information analysis means may solve a problem due to abnormality occurrence for the power transmitted from the ESS and a difference between actual used power and the transmitted power.

In order for an ESS operating system to conduct various controls so as to supply the power from the power grid to the battery of the ESS, various measurements, confirms, surveillances, and/or monitoring for the inside of the battery, the outside of the battery, a surrounding environment, and an entire system should be performed for each step (level). According to at least one exemplary embodiment of the present disclosure, the monitoring level may include four levels. Respective levels are connected by a network communication line, and serve to send and receive signals from each other, or issue or execute an instruction.

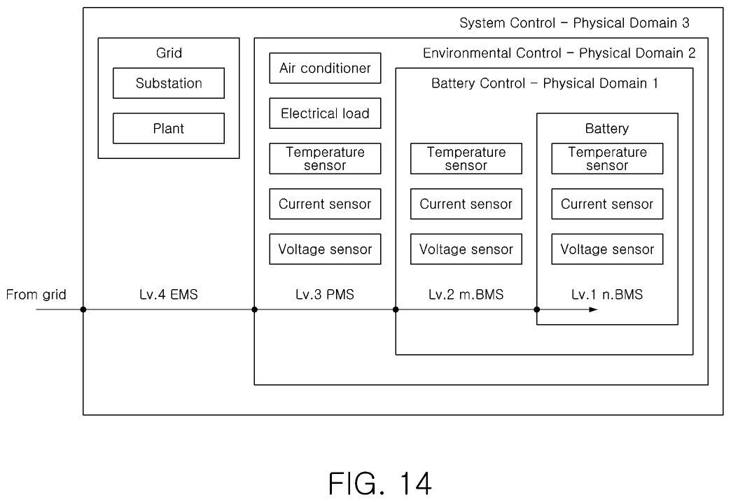

FIG. 14 illustrates an operation state management range when a monitoring level is constituted by Levels 1 to 4. FIG. 14 is provided an example in which some or all of the features of the present disclosure are applied to an ESS security management system.

According to at least one exemplary embodiment of the present disclosure, the monitoring level may include at least one of Level 1 including the BMS directly connected to the battery; Level 2 including Level 1 above and including a master BMS in which the BMSs of Level 1 are bundled and connected; Level 3 including Level 2 above and including a power management system (PMS) in which at least one of cooling and heating, the load, and the grid is controlled, and Level 4 including Level 3 above, and including a top-level energy management system (EMS) controlling at least one of the ESSs and the power systems in various regions. When the monitoring level is constituted by four steps, the monitoring may be specifically constituted by multiple levels as below.

The battery charging management system of the ESS using four levels may include a power use information collection unit collecting power use information related to actual charging power and other power (e.g., heater power, BMS balancing power, V2L power, external leakage loss power, etc.), an information analysis unit distinguishing or analyzing the information collected by the power use information collection unit, and a charging execution unit to perform charging stop or charging state control based on such an analysis result, and perform battery charging management.

Further, some or all of the features of the present disclosure may be used, and applied to an electric energy supply method and a system thereof. More specifically, the present disclosure relates to an electric energy supply method that efficiently supplies the power to an electric energy storage or electric energy consumption region including the energy storage system (ESS) through the grid that is supplied with the electricity from the power supply source, and an electric energy supply device and an electric energy supply system using the same.

Further, in supplying the power from the grid and the ESS, information on power consumption and the remaining electric energy is collected and evaluated to efficiently control and manage charging/discharging of the ESS or supplying of electric energy from the grid, so the electric energy of the grid may be optimized, loss due to excessive power or peak power may be optimized and minimized, and grid overload may be suppressed. Further, since a complementary relationship between the grid and the ESS may be maintained, a high output is available in spite of a shortage of the total supply electric energy of the grid, a momentary power outage, and power cut-off, so there is an advantage in that system power is enabled to be stably demanded and supplied.

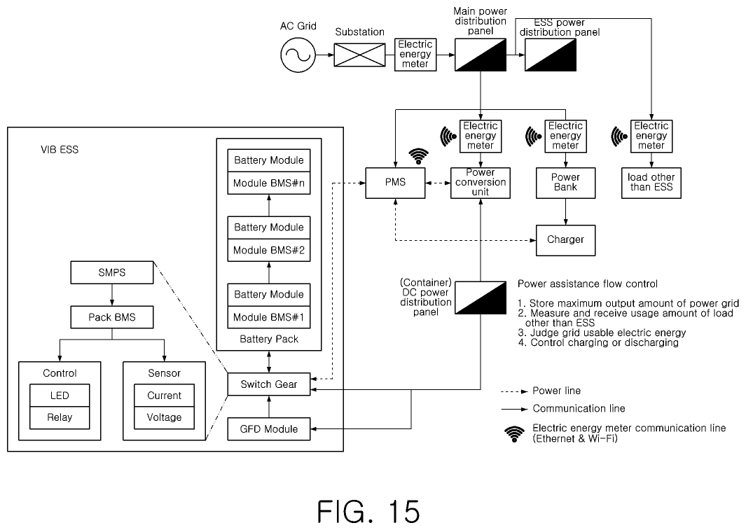

FIG. 15 exemplarily illustrates a system that supplies the power to the ESS and the power consumption region from the grid, controls information on consumable power obtained from the PMS of the ESS and power supplying to the power consumption region, and performs electric energy supplying including ESS charging/discharging management.

There may be provided an electric energy supply system that includes an ESS that is supplied with the power through the grid and performs charging/discharging, a charger that is supplied with the power from a power source of at least one of the ESS or the grid, and an auxiliary facility that is supplied with the power of the load other than the ESS, and includes a step of storing maximum outputtable power outputtable from the grid; a step of measuring or receiving the use electric energy of the load other than the ESS of the auxiliary facility; a step of measuring the use electric energy of the grid; and a step of controlling the charging or discharging of the ESS based on the power information collected in each step.

For example, an LIB emits heat and influences a battery life-span upon high output, but the vanadium ion battery (VIB) is capable of stable high output. Further, the LIB has a limit such as 1 C charging and 1 C discharging, but the VIB is capable of input/output flow control with the high output, and for example, when the power outage of the grid occurs, the ESS using the VIB is capable of assisting both the grid and the charger with the high output, so in particular, in the case of the ESS adopting the VIB, ESS charging/discharging management is very efficiently possible. In particular, since there is no fire risk due to overload in the case of the VIB, when the VIB is applied to the ESS of the present disclosure, the ESS may be a very effective power supply system in that the electric energy supply system of the present disclosure may be preferably applied while guaranteeing a safety in various auxiliary facilities. Further, since it is possible to supply energy safely and efficiently in the present disclosure, the present disclosure may be utilized as an energy supply means that is very effective, safe, and eco-friendly in energy saving, or energy environment, realization of carbon neutrality, etc.

Additionally, by utilizing some or all of the features of the present disclosure, a high C-rate output and cell balancing control according to the output may also be performed.

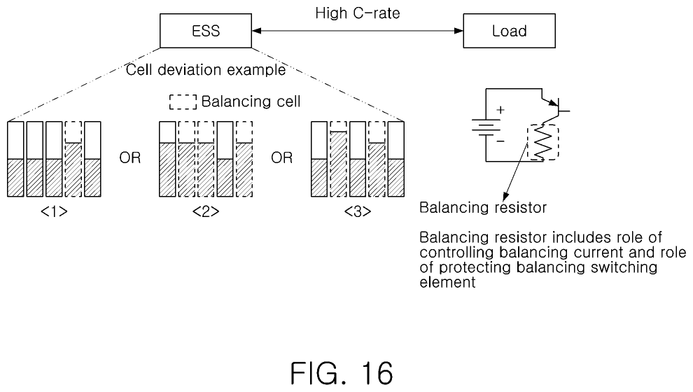

FIG. 16 is a conceptual view illustrating cases 1, 2, and 3 in which charging/discharging of the ESS is made at high C-rate with respect to a specific load, and various cell deviations with respect to internal battery cells of the ESS.

The present inventors recognize a problem in that a cell deviation occurrence probability and a deviation voltage increase upon high C-rate charging/discharging. As a solving method, a balancing current amount may be controlled by pulse width modulation (PWM), and the balancing current amount may be controlled by a scheme such as balancing with a maximum current amount at the high C-rate and balancing with a minimum current amount at a low C-rate.

As a result, since the balancing current is fluidly controlled, it is possible to stably maintain the high C-rate. For example, when cells in which cell deviations are generated are many, the PWM may also be controlled so as to achieve more balancing with respect to a specific cell.

A specific balancing scheme may be variously applied, and is not limited, and it is fundamentally important to fluidly control the balancing current. Further, since a resistance value of a balancing current limiting element may protect a balancing switch element, the resistance value may be lowered maximally, and the balancing current may also be controlled through current control through the PWM control.

Further, the present inventors also recognize a problem in that there may be a concern about stopping a cell monitoring BMS operation when the number of cells excessively discharged increases upon high c-rate charging/discharging.

When high-output discharge is performed when a battery power source is used as in an existing configuration or the related art, a stable operation is impossible due to input power variation of the BMS. That is, when the power supplying of the BMS is interrupted, the ESS power is generally interrupted, so there are many difficulties upon the high-output discharge. Further, when an external power source is used as in the existing/related art, there is a problem in that there is a rise in unit price due to addition of parts such as multiple connector wires, addition of a manufacturing process required therefor, and overall cost addition.

As the solving method, it is considered that when only lowest voltage is input, a boosting circuit may be configured so that the BMS may normally operate. Battery voltage is primarily input, and the input voltage is changed (boosted) to voltage so as for the BMS to operate, and provided as a BMS power input.

As a result, even when the deviation of the battery is generated, the BMS is enabled to stably operate, and even when multiple excessive discharge batteries are generated, the BMS is enabled to stably operate, and since only a minor number of elements are added to an internal circuit board of the BMS, the exemplary embodiment is enabled to be implemented without unit price rise minimization and particular process addition.

The exemplary embodiments of the present disclosure may also be described as follows.

At least some exemplary embodiments provide a power control system including: an energy storage system (ESS) connected to a power grid and having a battery; a power conversion unit operatively connected to the power grid and the energy storage system (ESS); and a control unit providing a control to perform a charging procedure and a discharging procedure for the battery by giving a priority to power conversion efficiency of the power conversion unit.

In order to give the priority to the power conversion efficiency of the power conversion unit (PCS), the battery has higher efficiency than the power loss of the power conversion unit (PCS), and is possible to stably operate in spite of showing any output of the power conversion unit (PCS).

In order to give the priority to the power conversion efficiency of the power conversion unit (PCS), the battery is implemented to be charged with voltage at a predetermined level or more and wait for efficient discharging and to be charged with an optimal electric energy according to the specification of the power conversion unit (PCS) for efficient charging.

Here, the voltage at the predetermined level or more may be variable according to the capacity of the battery, the charging/discharging condition, the management of the power control system, etc. For example, it may also be judged that 0.5 V is suitable for the predetermined level, and the predetermined level may be set based on a related experiment, or various measurement and management experience values. Specific voltage at a predetermined level may also vary depending on the life-span of the battery, and voltage at a predetermined level required may also be changed by an appropriate control according to a situation.

Provided is a power control system in which the battery is a vanadium ion battery (VIB).

Provided is a power control system which has an output between 0.2 C and 1 C in which the efficiency of the vanadium ion battery (VIB) is highest.

The control unit performs a control of calculating the optimal charging electric energy of the battery, comparing the calculated electric energy and the extra power of the power grid, and confirming whether the charging electric energy of the battery matches the optimal efficiency range of the power conversion unit (PCS), for the charging procedure.

The control unit selectively performs at least one of a control of setting the calculated electric energy to the charging power, a control of setting the maximum efficiency range of the power conversion unit (PCS) to the charging power, and a control of setting the minimum efficiency range of the power conversion unit (PCS) to the charging power.

The control unit conducts discharging in the maximum efficiency range of the power conversion unit (PCS) when the electric energy of the power grid is insufficient for the discharging procedure.

The control unit performs the charging procedure if the battery voltage is not optimal discharging voltage when the electric energy of the power grid is extra.

The energy storage system (ESS) includes a charger for electric vehicle charging, and the control unit provides a management control to correspond to the optimal efficiency range with respect to the power conversion by controlling charging/discharging of the energy storage system (ESS) according to the charging speed of the electric vehicle.

Additionally, at least some exemplary embodiments provide a control method of the power conversion system (PCS), which uses a power conversion unit that provides a control of transferring at least one of power of a power grid and power of an energy storage system (ESS) to an electric vehicle charging system and a management control to correspond to the optimal efficiency range with respect to the power conversion by controlling charging/discharging of the energy storage system (ESS) according to the charging speed of the electric vehicle, and performs a control the power conversion unit to perform the power conversion according to a specific charging/discharging range of the ESS so as to satisfy the optimal efficiency range of the power conversion system (PCS) connected to the ESS by considering power efficiency.

A vanadium ion battery (VIB) having a wider charging/discharging rate (C-rate: C) range than the lithium-based battery is applied to the energy storage system (ESS).

The vanadium ion battery (VIB) may implement the wide charging/discharging rate (C-rate) range because there is no irreversible reaction due to a phase change from a solid to an ion of lithium.

The management control is performed to correspond to the optimal efficiency range with respect to the power conversion by controlling charging/discharging of the energy storage system (ESS) according to the charging speed of the electric vehicle to perform both the discharging and the charging of the energy storage system (ESS) during the electric vehicle charging procedure.

Here, performing both the charging and the discharging may mean that the charging and the discharging are performed jointly. However, the performing of both the charging and the discharging does not mean that the charging and the discharging are particularly simultaneously performed. That is, the performing of both the charging and the discharging means that the ESS is discharged and the ESS is charged while the charging procedure of the electric vehicle is performed.

A specific charging/discharging range of the VIB ESS is determined according to the specification of the PCS. Due to a feature in which the vanadium ion battery has a wider charging/discharging (C-rate) range than the lithium ion battery (LIB), the power control system may perform a control so as to satisfy the optimal efficiency range of the PCS.

At least some exemplary embodiments provide a PCS operatively connected to a power grid and an energy storage system (ESS), which includes: a conversion unit converting the power of the power grid; and a control unit providing a control of transferring the power of the power grid to an electric vehicle charging system and a management control to correspond to an optimal efficiency range with respect to power conversion by controlling charging/discharging of the energy storage system (ESS) according to an electric vehicle charging speed.

Here, the optimal efficiency range may also be determined according to the specification of the PCS. For example, referring back to FIGS. 3A to 3C, the optimal efficiency range of the PCS may have a range of 50 kW to 100 kW or 100 kW to 200 kW. In addition, it may be regarded that the efficiency for the power conversion may become a reference of the PCS control by controlling the charging/discharging of the ESS. Meanwhile, the efficiency for the power conversion may be round-trip efficiency considering performing of both the charging and the discharging, and when the power conversion technology of the present disclosure is used, related round-trip efficiency may be enhanced.

A vanadium-based battery having a wider charging/discharging rate (C-rate: C) range than the lithium-based battery is applied to the energy storage system (ESS). The vanadium-based battery may implement the wide charging/discharging rate (C-rate) range because there is no irreversible reaction due to a phase change from a solid to an ion of lithium. The wide charging/discharging rate (C-rate) range is 0.2 to 10 C.

Here, a numerical range of the charging/discharging (C-rate) may be variable according to a capacity, a control scheme, a management environment, etc., of the vanadium ion battery (VIB). That is, even though the numerical value exceeds or departs from 0.2 to 10 C provided above, the VIB may be enabled to be managed more efficiently than the lithium ion battery (LIB) in the related art in spite of performing the control such as the charging/discharging control according to the present disclosure.

At least some of components and functions of the control unit can be implemented in the PCS of the battery management system (BMS). At least some of the components and the functions of the control unit could be implemented in the power bank of the battery management system (BMS).

The management control is performed to correspond to the optimal efficiency range with respect to the power conversion by controlling charging/discharging of the energy storage system (ESS) according to the charging speed of the electric vehicle to perform both the discharging and the charging of the energy storage system (ESS) during the electric vehicle charging procedure.

Provided is a power conversion unit in which the electric vehicle charging procedure enters a low-speed charging interval after a high-speed charging interval first starts, and the power of the power grid is primarily used in the high-speed charging interval to charge the electric vehicle, and the power grid is assisted by performing the discharge of the energy storage system (ESS), and the discharging and the charging of the energy storage system (ESS) are performed according to a state of the power grid in the low-speed charging interval.

Here, the high-speed charging and the low-speed charging as concepts relative to each other may also be variable every that time according to the power supply state of the power grid, the discharge situation of the ESS, etc. The electric vehicle charging may be basically divided into three levels. Level 1 may be regarded as low-speed charging (to 16 A) made when a general outlet is used. Level 2 is charging using current of 32 A, and is referred to as slow-speed charging in Korea when AC power is charged in the vehicle. Level 3 which supplies direct current of 400 V or direct current equal to or more than 400 V is referred to as rapid-speed charging in Korea. Therefore, in a first half of the electric vehicle charging, high-speed (rapid) charging is made by DC supplying in which the power is relatively high and the speed is fast, and in a second half, low-speed (slow) charging is made by AC supplying in which the power is relatively low and the speed is slow. As another method, charging being made at the high speed or the low speed may also be defined and judged as a charging/discharging rate (C-rate) concept.

The managing and controlling of the power conversion to correspond to the optimal efficiency range by controlling the charging and the discharging of the energy storage system (ESS) according to the electric vehicle charging speed, in which the power grid connected to the energy storage system (ESS) has a maximum electric energy, and the charger connected to the energy storage system (ESS) and the power grid has a requested electric energy requested for charging the electric vehicle, which includes: a step of charging the electric vehicle by discharging the energy storage system (ESS) for a power which is in a range of exceeding the maximum electric energy when the requested electric energy is equal to or larger than the maximum electric energy; and a step of charging the energy storage system (ESS) with power in a range below the maximum electric energy when the requested electric energy is smaller than the maximum electric energy.

Provided is a power conversion unit in which the energy storage system (ESS) includes: at least one secondary battery capable of charging and discharging; an input unit receiving power from a power grid in order to charge the secondary battery; an output unit providing the power to a charger for charging an electric vehicle by discharging the secondary battery; and a controller operatively connected to the secondary battery, the input unit, and the output unit and controlling a state of charge (SoC) of the secondary battery when the electric vehicle charging starts and a state of charge (SoC) of the secondary battery when the electric vehicle charging ends to be maintained to be similar to each other.

Here, maintaining the states of charge (SoCs) to be similar may also be regarded as a condition which is satisfied when the relative level at the charging start/end is included in the specific range. For example, it may also be regarded that a case where the states of charge (SoCs) at the charging start and end are within 15% with respect to each other is a state in which the SoCs are maintained to be similar. Depending on the management of the energy storage system (ESS), the corresponding range percentage (%) or the specific numerical range may be variable.

Further, at least some exemplary embodiments provide a power conversion unit efficiency control system which includes: an energy storage system (VIB ESS) including a vanadium ion battery; a power conversion system (PCS) connected to a power grid and the VIB ESS; and a power conversion unit operatively connected to the PCS, in which the power conversion unit performs a control so as to conduct power conversion according a specific charging/discharging range of the VIB ESS so as to satisfy an optimal efficiency range of the PCS by considering power efficiency.

The specific charging/discharging range of the VIB ESS is determined according to the specification of the PCS. Due to a feature in which the vanadium ion battery has a wider charging/discharging (C-rate) range than the lithium-ion battery (LIB), the power control system may perform a control so as to satisfy the optimal efficiency range of the PCS. The power conversion unit performs a control so that the VIB ESS is charged or discharged in a range of 50 A to 200 A when the optimal efficiency range of the PCS is in a range of 50 kW to 200 kW.

Even though it is described that all components constituting the exemplary embodiment of the present disclosure are combined into one or operate in combination with each other, the present disclosure is not particularly limited to the exemplary embodiment, and one or more of all components may be selectively combined and operated within a purpose scope of the present disclosure. Further, each of all components may be implemented as one independent hardware, but some or all of respective components are selectively combined to be implemented as a computer program having a program module performing some or all functions combined in one or a plurality of hardware. Codes and code segments constituting the computer program will be able to be easily inferred by those skilled in the art of the present disclosure. The computer program is stored in computer readable media, and read and executed by a computer to implement the exemplary embodiment of the present disclosure. The storage media of the computer program include a magnetic recording medium, an optical recording medium, and a storage medium including a semiconductor recording element. Further, the computer program for implementing the exemplary embodiment of the present disclosure includes a program module transmitted through an external device in real time.

It is to be understood that the above-described embodiments are to be considered in all respects as illustrative and not restrictive, the scope of the present disclosure being indicated by the appended claims rather than by the foregoing detailed description. In addition, it should be construed that all changes and modifications that are derived from the meanings and ranges of the claims and concepts equivalents thereto are included within the scope of the present disclosure.

What is claimed is:

1. A power control system comprising:
an energy storage system (ESS) that is connected to a power grid and includes a battery;
a power conversion system (PCS) operatively connected to the power grid and the energy storage system (ESS); and
a control unit configured to control a charging procedure and a discharging procedure for the battery by giving a priority to power conversion efficiency of the PCS.

2. The power control system according to claim 1, wherein in order to give the priority to the power conversion efficiency of the PCS, the battery is configured to have higher efficiency than a power loss of the PCS and to operate in a more stable manner when compared to a conventional PCS.

3. The power control system according to claim 1, wherein in order to give the priority to the power conversion efficiency of the PCS, the battery is configured to be charged with voltage at a predetermined level or greater and wait for efficient discharging and to be charged with an optimal electric level according to a specification of the PCS for efficient charging.

4. The power control system according to claim 1, wherein the battery relates to a vanadium ion battery (VIB).

5. The power control system according to claim 4, wherein the power control system has an output between 0.2 C and 1 C in which an efficiency of the vanadium ion battery (VIB) is highest.

6. The power control system according to claim 1, wherein, for the charging procedure, the control unit is further configured to:
calculate an optimal charging electric energy of the battery,
compare the optimal charging electric energy and an extra power of the power grid, and
confirm whether the optimal charging electric energy of the battery matches an optimal efficiency range of the PCS when the extra power of the power grid exists.

7. The power control system according to claim 6, wherein the control unit is further configured to selectively perform at least one of:
setting the calculated electric energy to the charging power,
setting a maximum efficiency range of the PCS to the charging power, and
setting a minimum efficiency range of the PCS to the charging power.

8. The power control system according to claim 1, wherein the control unit is further configured to conduct discharging in a maximum efficiency range of the PCS when an electric energy of the power grid is insufficient for the discharging procedure.

9. The power control system according to claim 8, wherein the control unit is further configured to perform the charging procedure if a battery voltage is not an optimal discharging voltage when the electric energy of the power grid is in surplus.

10. The power control system according to claim 1,
wherein the energy storage system (ESS) further comprises a charger for electric vehicle charging, and
wherein the control unit is further configured to provide a management control to correspond to an optimal efficiency range with respect to the power conversion by controlling charging/discharging of the energy storage system (ESS) according to a charging speed of the electric vehicle.

11. A power conversion unit efficiency control system comprising:
an energy storage system (ESS) comprising a vanadium ion battery (VIB);
a power conversion unit connected to a power grid and the ESS; and
a power conversion unit operatively connected to the power conversion system (PCS),
wherein the power conversion unit performs a control to achieve power conversion according to a specific charging/discharging range of the ESS so as to satisfy an optimal efficiency range of the PCS by considering power efficiency.

12. The power conversion unit efficiency control system according to claim 11, wherein the specific charging/discharging range of the ESS is determined according to a specification of the PCS.

13. The power conversion unit efficiency control system according to claim 11, wherein due to a feature in which the vanadium ion battery has a wider charging/discharging (C-rate) range than a lithium-ion battery (LIB), and the power control system is capable of performing a control so as to satisfy the optimal efficiency range of the PCS.

14. The power conversion unit efficiency control system according to claim 11, wherein the power conversion unit performs a control so that the ESS is charged or discharged in a range of 50 A to 200 A when the optimal efficiency range of the PCS is in a range of 50 kW to 200 kW.

15. A control method of a power conversion unit, the contort method comprising:
using the power conversion unit to provide:
a control of transferring at least one of a power of a power grid and a power of an energy storage system (ESS) to an electric vehicle charging system, and
a management control to correspond to an optimal efficiency range with respect to power conversion by controlling charging/discharging of the ESS according to an electric vehicle charging speed,
wherein the power conversion unit performs a control to achieve the power conversion according to a specific charging/discharging range of the ESS so as to satisfy the optimal efficiency range of a power conversion system (PCS) connected to the ESS by considering power efficiency.

16. The control method according to claim 15, wherein a vanadium ion battery (VIB) having a wider charging/discharging rate (C-rate) range than a lithium-based battery is applied to the energy storage system (ESS).

17. The control method according to claim 16, wherein the vanadium ion battery (VIB) is capable of the wide charging/discharging rate (C-rate) range because irreversible reactions due to a phase change from a solid to an ion of the lithium do not occur in the VIB.

18. The control method according to claim 15, wherein the management control is performed to correspond to the optimal efficiency range with respect to the power conversion by controlling charging/discharging of the energy storage system (ESS) according to the charging speed of the electric vehicle to perform both the discharging and the charging of the energy storage system (ESS) during an electric vehicle charging procedure.

19. The control method according to claim 15, wherein the specific charging/discharging range of the VIB ESS is determined according to a specification of the PCS

20. The control method according to claim 15, wherein due to a feature in which the vanadium ion battery has a wider charging/discharging (C-rate) range than a lithium ion battery (LIB), the power control system provides control to satisfy the optimal efficiency range of the PCS.
